(19) United States
(12) Patent Application Publication
(10) Pub. No.: US 2012/0163894 A1
(43) Pub. Date: Jun. 28, 2012

(54) KEYS AND KEYBOARD COMPRISING THE SAME

(76) Inventors: Heng Xiao, Shenzhen (CN); Junfeng Liu, Shenzhen (CN); Luo Wenhai, Shenzhen (CN)

(21) Appl. No.: 13/379,956

(22) PCT Filed: Jul. 26, 2010
(86) PCT No.: PCT/CN2010/075464

§ 371 Date: Dec. 21, 2011

(30) Foreign Application Priority Data
Jul. 30, 2009 (CN) 200910109205.2

(51) Int. Cl. B41J 5/12

(52) U.S. Cl. 400/490

(57) ABSTRACT

A key comprising a light transmitting key base; a three-dimensional cured resin layer disposed on a lower surface of the base; and a pattern layer disposed on a lower surface of the three-dimensional cured resin layer is provided. The three-dimensional cured resin layer may be formed with a microstructure on a lower surface facing the upper surface of the pattern layer. Further, a keyboard comprising the same is also provided.

### CROSS-REFERENCE TO RELATED APPLICATION

This patent application is a § 371 national stage patent application based on International Patent Application No. PCT/CN2010/075464, filed Jul. 26, 2010,entitled “KEY AND KEY BOARD COMPRISING THE SAME”, which claims the priority to, and the benefit of Chinese Patent Application No. 200910109205.2, filed with the State Intellectual Property Office of the P. R. China on Jul. 30, 2009, the entire content of both applications are incorporated herein by reference.

### FIELD

The present disclosure relates to a typing input device, more particularly, to an improved key and a keyboard comprising the same.

### BACKGROUND

Keys are widely used in mobile terminals, electronic devices and daily lives. For example, with the increasing of cell phone users, designs of cell phones play an increasingly significant role on the preference of the users, which further affects the market shares of cell phone suppliers. Therefore, there is a need to further improve aesthetic design of cell phones, in order to survive in the market competition.

Keys are used frequently in a cell phone and have a great influence on the design of terminals such as a mobile phone, a smart phone, an MP3 player, a PDA, or a tablet. The keys in prior art usually comprise a key base and a pattern layer, in which the pattern layer is usually formed on the base by silk-screen printing, coating, laser carving, electric plating, etc. The method for forming a light transmitting key comprises the steps of: injection molding a transparent key base; printing inks on the surface of the base; laser carving a pattern layer on the printed surface of the base; and coating a protective oil layer on the carved surface. However, devices formed therefrom have monotone color which may not meet current customer requirements of personality.

Chinese patent No. ZL200610069845 discloses a method for preparing colorful keys for cell phones, which is realized by overlaying colorful layers in turn by vacuum electroplating. However, the process is complex, and the devices made therefrom have high cost with low qualified yield rate.

### SUMMARY

The present disclosure is directed to, in an embodiment, a key with a simplified manufacturing process and a colorful visual effect. Further, a keyboard comprising the same is also provided.

According to an aspect of the present disclosure, a key may be provided, comprising: a light transmitting key base; a three-dimensional cured resin layer disposed on a lower surface of the base; and a pattern layer disposed on a lower surface of the three-dimensional cured resin layer. The three-dimensional cured resin layer may be formed with microstructure on a lower surface thereof.

According to another aspect of the present disclosure, a keyboard comprising at least one of the key as described above is also provided.

Because a lower surface of the key base is disposed with a three-dimensional cured resin layer which is further formed with a microstructure comprising a plurality of protrusions, the key may be presented with colorful effects when bird viewing the key from an upper surface of the key base due to differences among the light transmitting velocities for different colors and light diffraction effects when light passes through the protrusions formed on the lower surface. Moreover, the preparing process for the key is simplified.

Additional aspects and advantages of the embodiments of present disclosure will be given in part in the following descriptions, become apparent in part from the following descriptions, or be learned from the practice of the embodiments of the present disclosure.

### BRIEF DISCRIPTION OF THE DRAWINGS

These and other aspects and advantages of the present disclosure will become apparent and more readily appreciated from the following descriptions taken in conjunction with the drawings in which:

FIG. 1 is a schematic sectional view of a key according to an embodiment of the present disclosure;

FIG. 2 is a plan view of a front surface of a mobile terminal comprising a key according to an embodiment of the present disclosure; and

FIG. 3 is an enlarged view of part A shown in FIG. 1, showing a microstructure formed on the three-dimensional cured resin layer according to an embodiment of the present disclosure.

Figure Numerals

1: ultra violet light cured adhesive layer;

2: plastic sheet;

3: three-dimensional cured resin layer;

4: a layer of a metal film;

5: pattern layer;

6: microstructure; and

7: key.

### DETAILED DISCRIPTION OF THE EMBODIMENTS

Reference will be made in detail to embodiments of the present disclosure. The embodiments described herein are explanatory, illustrative, and used to generally understand the present disclosure. The embodiments shall not be construed to limit the present disclosure. The same or similar elements and the elements having same or similar functions are denoted by like reference numerals throughout the descriptions.

In the following, a mobile phone with a keyboard will be described for illustration purpose. However, it is obvious for a person normally skilled in the art to apply the solution described hereinbelow to any other terminals such as a smart phone, an MP3 player, a PDA, or a tablet, etc., which also falls within the scope of the present disclosure which is defined herein by the following claims and their equivalents.

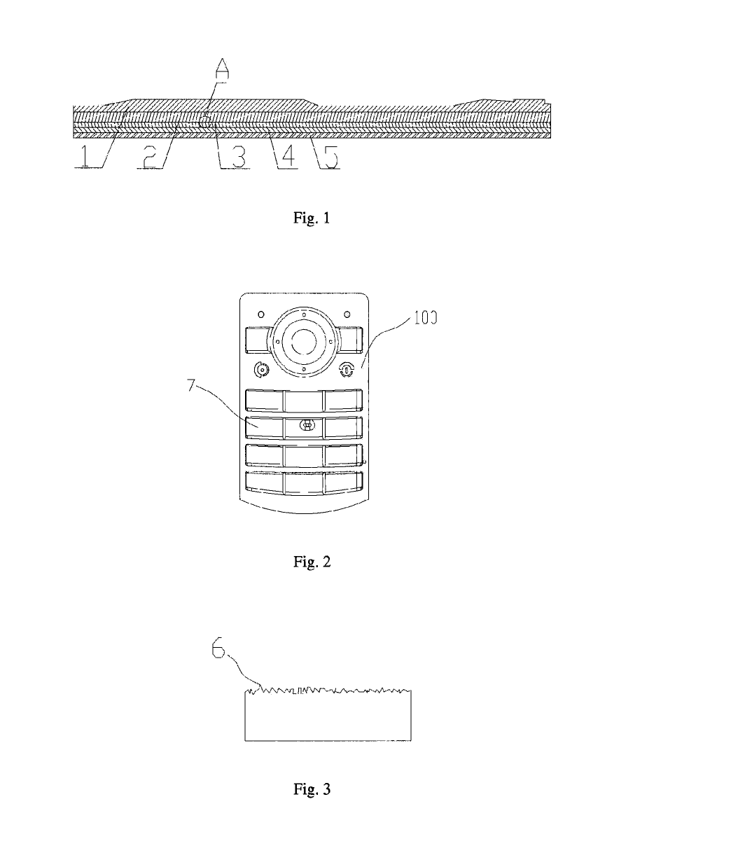

In the following, as shown in FIG. 1, a key comprises a light transmitting key base, a three-dimensional (3D) cured resin layer 3, and a pattern layer 5. The 3D cured resin layer 3 is disposed on a lower surface of the key base, whose lower surface is formed with a microstructure. The pattern layer 5 is disposed on a lower surface of the 3D cured resin layer 3.

The key base is required to have a certain light transmittance, which may be any light transmitting plastic material in the art. According to an embodiment of the present disclosure, the key base may be solvent resistant polycarbonate (PC), poly (ethylene terephthalate) (PET), etc.

According to an embodiment of the present disclosure, the key base may include a plastic sheet 2 and an ultra violet (UV) light cured adhesive layer 1 formed on the plastic sheet 2. In an embodiment, the plastic sheet 2 may have a thickness ranging from about 0.15 mm to about 0.2 mm, and the UV light cured adhesive layer 1 may have a thickness of about 0.15 mm to about 0.3 mm. The UV light cured adhesive layer 1 may be formed on the outermost surface of the key in use, so the requirement on the performance of the UV light cured adhesive layer 1 is relatively strict. According to an embodiment of the present disclosure, the UV light cured adhesive layer 1 may have a pencil hardness of no less than F/500 g (when a pencil having a hardness of F and a cylindrical core with an exposed length of about 3 mm and a flat tip, which is commercially available from Mitsubishi Pencil Co., Ltd., moves at a uniform speed in a direction of 45° with respect to a surface to be tested under a load of about 500 g at five different places on the surface of the sample for about 10 mm, the surface has no scratches), an adhesive force with the plastic sheet 2 of no less than 4B, a resistance to cosmetic products including hand creams, sunscreens, etc., and a wear resistance of no less than 300 circles. According to an embodiment of the present disclosure, the UV light cured adhesive layer 1 may be 126-8 UV light cured adhesive available from Samwoo Chemicals Ltd.

The 3D cured resin layer 3 is formed with a microstructure on a lower surface thereof. The microstructure comprise a plurality of protrusions which may have various kinds of shapes, such as lines or points etc, without limitation. According to an embodiment of the present disclosure, the lines may be straight lines, curves, meander lines, or parallel lines. There are no special limits on the cross section of the microstructure such as the lines or points. According to an embodiment of the present disclosure, the cross section of the lines may be rectangular, trapezoid, triangular, semicircular, etc., and the cross section of the points may be rectangular, square, diamond, hexagonal, triangular, cylindrical, conoid, hemispheric, polyhedral, etc.

According to an embodiment of the present disclosure, each protrusion may have an average value of a height, a width, and a length of about 1 nm to about 15 μm, preferably from about 10 nm to about 10 μm, further preferably from about 10 nm to about 500 nm. As to the points, the length and the width may refer to the largest length and the largest width of the cross section of the protrusion respectively. The average spacing between two adjacent protrusions may range from about 1 nm to about 500 μm, preferably from about 10 nm to about 50 μm. As used herein, the term “average spacing” may refer to the average distance between two adjacent protrusions.

According to an embodiment of the present disclosure, the 3D cured resin layer 3 is preferably made of a UV light cured adhesive. According to an embodiment of the present disclosure, the moisture content of the UV light cured adhesive may be low, generally less than 0.1%, to avoid the presence of water on the surface thereof after solidification. In an embodiment, the UV light cured adhesive may be 3095-T UV adhesive available from DYMAX UV Adhesives & Equipment (Shenzhen) Ltd, P. R. C. The 3D cured resin layer 3 may have a thickness of about 15 μm to about 20 μm.

According to another embodiment of the present disclosure, a method for preparing the 3D cured resin layer 3 may be provided. The method may comprise the steps of: coating UV light cured adhesive for forming the 3D cured resin layer 3 on a surface of a mold formed with a microstructure or microstructures; covering the plastic sheet 2 on the UV light cured adhesive for forming the 3D cured resin layer 3; roll coating the plastic sheet 2 and the UV light cured adhesive under a pressure of no greater than about 10 MPA; and irradiating by a UV lamp with a wavelength of about 200 nm to about 400 nm for about 1 s to about 1.5 s to solidify the UV light cured adhesive. After the key base is removed from mold, the lower surface of the plastic sheet 2 is covered with a 3D cured resin layer 3 formed with a microstructure. In other words, the microstructure on the surface of the mold is transferred to the lower 3D cured resin layer 3 by the UV light cured adhesive.

In this embodiment, the key may further comprise a layer of metal film 4 on the lower surface of the 3D cured resin layer 3, to increase the metal texture and transmittance of the key, thus presenting the key with colorful effect. The key may have a total light transmittance of about 20% to about 30%. The layer of the metal film 4 may be made of any metal that may be coated on a substrate. In an embodiment, the metal may be selected from the group consisting of nickel, chromium, tin, indium, indium tin alloy, stainless steel, and combinations thereof. In the present embodiment, the metal may be preferably indium tin alloy. There are no special limits on the method for preparing the layer of the metal film. In an embodiment, the method may be physical vapor deposition (PVD), which may include sputtering coating, ion plating or evaporation coating, with the sputtering coating being preferable. The metal film may have a thickness of about 1 μm to about 2 μm.

According to an embodiment of the present disclosure, the pattern layer is on the outermost surface of the key. According to an embodiment of the present disclosure, the pattern layer may be formed into a numeric, alphabetic or other desired pattern layer as conditions may require. Preferably, the pattern layer may be printed with ink on the lower surface of the layer of the metal film 4 by screen printing. The screen printing is commonly practiced in the art. According to an embodiment of the present disclosure, the printing may be performed by a 250 mesh screen. The printing methods and inks are known to those skilled in the art.

Additional details of the present invention will be provided as follows by some embodiments of the present disclosure.

### First Embodiment

A method of preparing a key 7 for a cell phone as shown in FIG. 2 comprises the following steps.

A surface of a first mold was carved to obtain a microstructure with a combination of various irregular shapes by a precise laser beam. The carved surface of the mold was coated with a 3095-T UV light cured adhesive available from DYMAX UV Adhesives & Equipment (Shenzhen) Ltd, P.R.C. A PET sheet with a thickness of about 0.175 mm was pressed on the UV light cured adhesive, roll coated with the UV light cured adhesive, and irradiated by a UV lamp with a wavelength of about 200 nm for a time of about 1 second. Then the PET sheet was removed from the first mold. As the UV light cured adhesive has a good adhesive force with the PET sheet, the lower surface of the PET sheet was covered with a 3D cured resin layer with a microstructure being transferred from the structure formed on the inner surface of the first mold.

A second mold with concavities corresponding to the shape of the keys, with a depth of about 0.2 mm was prepared accordingly. The surface of the second mold was coated with a 126-8 UV light cured adhesive available from Samwoo Chemicals Ltd. Then keys on the upper surface of the PET sheet were formed by the same steps for preparing the 3D cured resin layer 3 as described above.

The 3D cured resin layer 3 was coated by PVD with a horizontal film plating machine commercially available form UVAT Technology Co., Ltd. The coating process was performed once using indium tin alloy as a target, with a cleaning vacuum of about 1×10⁻² Pa to about 5×10⁻² Pa, a cleaning power of about 600 W, a cleaning time of about 20 s, a coating vacuum of about 2×10⁻³ Pa to about 5×10⁻³ Pa, a coating power of about 3 KW, and a coating time of about 2 s. Then a metal film was formed on the lower surface of the 3D cured resin layer 3.

A pattern layer formed with patterns such as numerals, a canceling key and a calling key etc. was formed on the lower surface of the layer of the metal film with PH-HB-80931 type black inks, PH-HB-80933 type red inks, and PH-HB-80934 type green inks commercially available from Shenzhen Civada Precision Mold Accessories Co., Ltd., respectively.

According to an embodiment of the present disclosure, a keyboard comprising at least one of the key as described hereinabove is also provided. It should be noted that the term “keyboard” may includes any keypad, conventionally used keyboard, a plate formed with at least a press button and any other typing input device that is formed with key or keys. And the scope of the present disclosure is defined by accompanying claims and equivalents thereof accordingly.

Although explanatory embodiments have been shown and described, it would be appreciated by those skilled in the art that changes, alternatives, and modifications all falling into the scope of the claims and their equivalents can be made in the embodiments without departing from spirit and principles of the invention.

1. A key, comprising:
a light transmitting key base;
a three-dimensional cured resin layer disposed on a lower surface of the base; and
a pattern layer disposed on a lower surface of the three-dimensional cured resin layer, wherein
the three-dimensional cured resin layer is formed with microstructure on an lower surface thereof.

2. The key according to claim 1, wherein the three-dimensional cured resin layer has a thickness of about 15 μm to about 20 μm.

3. The key according to claim 1, wherein the microstructure comprises:
a plurality of protrusions formed on the lower surface of the three-dimensional cured resin layer having an average value of a height, a width, and a length of each protrusion ranging from about 1 nm to about 15 μm with an average spacing therebetween of about 1 nm to about 500 μm.

4. The key according to claim 3, wherein the average value ranges from about 10 nm to about 10 μm, and the average spacing ranges from about 10 nm to about 50 μm.

5. The key according to claim 3, wherein the three-dimensional cured resin layer is made of an ultraviolet light cured resin.

6. The key according to claim 1, further comprising a layer of metal film interposed between the pattern layer and the three-dimensional cured resin layer.

7. The key according to claim 6, wherein the metal film made from indium tin alloy has a thickness of about 1 μm to about 2 μm.

8. The key according to claim 6, wherein the key has a total light transmittance of about 20% to about 30%.

9. The key according to claim 1, wherein the key base includes:
a plastic sheet; and
an ultraviolet light cured adhesive layer formed on the plastic sheet.

10. A key board comprising at least one of the key according to claim 1.
